(19) United States
(12) Patent Application Publication
(10) Pub. No.: US 2024/0404268 A1
(43) Pub. Date: Dec. 5, 2024

(54) Training Models for Object Detection

(71) Applicant: Hewlett-Packard Development Company, L.P., Spring, TX (US)

(72) Inventors: Qian Lin, Palo Alto, CA (US); Augusto Valente, Campinas (BR); Otavio Gomes, Campinas (BR)

(73) Assignee: Hewlett-Packard Development Company, L.P., Spring, TX (US)

(21) Appl. No.: 18/699,701

(22) PCT Filed: Oct. 14, 2021
(86) PCT No.: PCT/US2021/054919

§ 371 Date: Apr. 9, 2024

(51) Int. Cl. G06V 10/82; G06V 10/774; G06V 10/776

(52) U.S. Cl. CPC G06V 10/82; G06V 10/774; G06V 10/776; G06V 2201/07

(57) ABSTRACT

In some examples, a computing device can include a processing resource and a memory resource storing instructions to cause the processing resource to cause a convolutional neural network (CNN) model to be trained with an initial training data set to detect an object included in annotated images included in the initial training data set, cause the trained CNN model to perform inferencing on unannotated images included in an inference data set to detect the object in the unannotated images, determine an error rate of the trained CNN model, and cause the trained CNN model to be further trained based on the error rate.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can be connected to scanner devices, cameras, and/or other image capture devices to convert physical documents into digital documents for storage.

### BRIEF DESCRIPTION OF THE DRAWINGS

FIG. 1 is an example of a system for training models for object detection consistent with the disclosure.

FIG. 2 is an example of a computing device for training models for object detection consistent with the disclosure.

FIG. 3 is a block diagram of an example system for training models for object detection consistent with the disclosure.

FIG. 4 is an example of a method for training models for object detection consistent with the disclosure.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

In some examples, the computing device can be communicatively coupled to an image capture device, a printing device, a multi-function printer/scanner device, and/or other peripheral devices. In some examples, the computing device can be communicatively coupled to the image capture device to provide instructions to the image capture device and/or receive data from the image capture device. For example, the image capture device can be a scanner, camera, and/or optical sensor that can perform an image capture operation and/or scan operation on a document to collect digital information related to the document. In this example, the image capture device can send the digital information related to the document to the computing device.

Such digital information can include objects. As used herein, the term “object” refers to an identifiable portion of an image that can be interpreted as a single unit. For example, an image (e.g., the digital information) captured by an image capture device, printing device, and/or other peripheral device may include an object, such as a vehicle, streetlamp, stop sign, a person, a portion of the person (e.g., a face of the person), and/or any other object included in an image.

Machine learning models/image classification models can be utilized to detect objects in such images. One machine learning model can include a convolutional neural network (CNN) model. As used herein, the term “CNN model” refers to a deep learning neural network classification model to process structured arrays of data. A CNN model can be utilized to perform object detection in images.

In order for a CNN model to perform object detection, the CNN model is to be trained. Previous approaches to training a CNN model for object detection include providing a training data set having images that include objects to be detected that are of a same category of object intended for detection. However, such a training approach may not provide for sufficient accuracy in object detection as a result of object misdetection by the CNN model.

Training models for object detection according to the disclosure can allow for object detection with an increase in accuracy as compared with previous approaches. Utilizing inferencing and further training, the CNN model can be revised to improve its object detection accuracy. Accordingly, such an approach can provide an accurate object detector with a lower error rate than previous approaches, which may be utilized in facial matching/recognition (e.g., in photographs, video images, etc.), face tracking for video conferencing calls, detection of a person in a video image, among other uses.

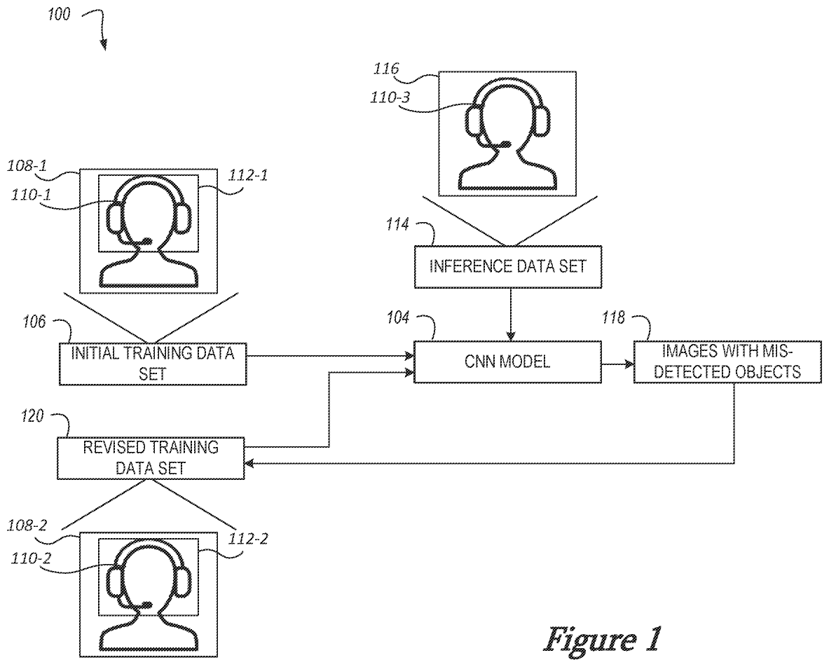

FIG. 1 is an example of a system 100 for training models for object detection consistent with the disclosure. The system 100 includes a computing device 102, a CNN model 104, an initial training data set 106, an inference data set 114, and a revised data set 120.

As mentioned above, the CNN model 106 can be utilized to perform object detection in images. Such images may be received by the computing device 102 for object detection from, for instance, an image capture device (e.g., a camera), an imaging device (e.g., a scanner), and/or any other device. Such images may be provided to the CNN model 104 for object detection. Prior to such actions, the CNN model 104 has to be trained. Training the CNN model 104 can be performed according to the steps as described herein.

As illustrated in FIG. 1, the computing device 102 can include an initial training data set 106. As used herein, the term “training data set” refers to a collection of related sets of information that is composed of separate elements used to train a model. For example, the CNN model 104 is to be trained to detect a particular object in an image. Accordingly, the initial training data set 106 includes a plurality of images having the particular object the CNN model 104 is to be trained to detect.

The object can be included in a category of objects intended for detection. In one example, the category of objects intended for detection can include a face of a subject in an image. For example, the CNN model 106 is to be trained to detect faces of people in images. Accordingly, the initial training data set 106 can include a plurality of images, each having faces of subjects that can be used to train the CNN model 106, as is further described herein.

The images included in the initial training data set 106 can be annotated images. As used herein, the term “annotated image” refers to an image having metadata describing content included in the image. The annotated images included in the initial training data set 106 can include bounding boxes 112-1 around the object 110-1. As used herein, the term “bounding box” refers to a shape that is a point of reference defining a position of an object in an image. For example, the bounding box 112-1 can define a position of the face (e.g., the object) of a subject in the annotated image 108-1 included in the initial training data set 106.

The computing device 102 causes the CNN model 104 to be trained with the initial training data set 106 to detect the object 110-1 included in the annotated images 108-1 included in the initial training data set 106. As used herein, the term “train” refers to a procedure in which a model determines parameters for the model from an input data set with known classes. For example, the CNN model 104 is trained by detecting objects 110-1 included in an input data set (e.g., the initial training data set 106).

Once the CNN model 104 is trained, the CNN model 104 can be utilized to detect objects in unannotated images. As used herein, the term “unannotated image” refers to an image that does not include metadata describing an object included in the image. However, in some examples, certain objects may not be detected by the trained CNN model 104. For example, certain objects on an unannotated image may not be detected by the trained CNN model 104 even though the object exists on the unannotated image, or other objects on the unannotated image may be erroneously detected as the object. For instance, the face of a subject included in an unannotated image of the unannotated images may not be detected by the trained CNN model 104, or an arm of the subject may be erroneously detected as the face of the subject. Other instances may include erroneous detection of non-human faces, images with complex textures (e.g., such as wires and/or text) being detected as human faces, etc. Training models for object detection can correct for such erroneous detection, as is further described herein.

To detect such erroneous object detection, the trained CNN model 104 can utilize the inference data set 114. As used herein, the term “inference data set” refers to a collection of related sets of information that is composed of separate elements that are analyzed by a model to detect objects included in the separate elements. For example, the inference data set 114 includes a plurality of unannotated images 116.

In some examples, the inference data set 114 can include unannotated images 116 without the objects 110-3. For example, the unannotated images 116 may include images of animals, high-texture images that do not include human faces, text, etc.

The computing device 102 causes the trained CNN model 104 to perform inferencing on the unannotated images 116 included in the inference data set 114 to determine whether the trained CNN model 104 detects an object in the unannotated images 116 (e.g., when there are no objects for detection). As used herein, the term “inferencing” refers to processing input data by a trained model to identify objects the trained model has been trained to recognize. Since the CNN model 104 is trained, it is to detect certain objects when received by the CNN model 104. However, if the trained CNN model 104 detects an object in an unannotated image 116, the computing device 102 can determine that the trained CNN model 104 has mis-detected an object (e.g., a false positive detection has occurred).

Accordingly, when an object is detected in an image 116 included in the inference data set 114, but not being of a category of objects intended for detection, misdetection has occurred. For example, the trained CNN model 104 may analyze 100 images 116 not having objects for detection but misidentify objects in 5 of the images when there are no faces (e.g., misidentify an animal's face as a human face, misidentify text as a human face, misidentify a high-texture portion of an image as a human face, among other examples). Such an example can be a false positive detection by the trained CNN model 104. Such images can be images with mis-detected objects 118.

In some examples, the inference data set 114 can include unannotated images 116 with the objects 113-3. For example, the unannotated images 116 may include images having faces (e.g., objects 110-3 for detection). In some examples, the computing device 102 may know the pre-determined position of the objects 110-3 in the unannotated images 116.

The computing device 102 causes the trained CNN model 104 to perform inferencing on the unannotated images 116 included in the inference data set 114 to determine whether the trained CNN model 104 detects an object in the unannotated images 116 (e.g., when there are objects for detection). If the trained CNN model 104 detects an object in an unannotated image 116, but the detected object is in a location on the unannotated page 116 that is different from the pre-determined position of the objects 110-3 on the page, the computing device 102 can determine that the trained CNN model 104 has mis-detected an object (e.g., a false negative detection has occurred).

Although the inference data set 114 is described above as having unannotated images 116 including images not having faces (e.g., objects 110-3) for detection or images having faces (e.g., objects 110-3) for detection, examples of the disclosure are not so limited. For example, the inference data set 114 may include combinations thereof.

The error rate of the trained CNN model 104 is determined. As used herein, the term “error rate” refers to a rate of misdetection of an object in unannotated images. For example, the trained CNN model 104 may incorrectly detect (e.g., mis-detect) objects in 5 out of 100 unannotated images, resulting in an error rate of 5%.

Misdetection of the object 110-3 includes an image 116 included in the inference data set 114 having an object 110-3 to be detected that was not detected. For example, the trained CNN model 104 may analyze 100 images 116 having objects 110-3 (e.g., 100 images having faces) and not detect faces in 5 of the images. Such an example can be a false negative detection by the trained CNN model 104.

As mentioned as an example above, the trained CNN model 104 may incorrectly detect (e.g., mis-detect) objects in 5 out of 100 unannotated images. The unannotated images that include mis-detected objects can be included in the images with mis-detected objects 118. In some examples, the results of the inferencing by the trained CNN model 104 may be determined by the computing device 102 (e.g., as described above). In some examples, the results of the inferencing by the trained CNN model 104 may be analyzed by a user, such as an engineer, technician, etc. The user may identify each unannotated image 116 which the trained CNN model 104 mis-detected an object 110-3. Such information may then be input to the computing device 102 by the user. Accordingly, in some examples, determining the error rate of the trained CNN model 104 can include receiving the error rate via an input to the computing device 102. The computing device 102 can then cause the trained CNN model 104 to be further trained based on the error rate, as is further described herein.

The computing device 102 can compare the error rate to a threshold amount. The threshold can be a predetermined threshold percentage. For example, the computing device 102 can compare the error rate (e.g., 5%) to a predetermined threshold amount (e.g., 0.5%). The computing device 102 determines the error rate is greater than the threshold amount. In response, the computing device 102 can cause the trained CNN model 104 to be further trained, as is further described herein.

As illustrated in FIG. 1, the computing device 102 can include a revised training data set 120. As used herein, the term “revised training data set” refers to a collection of related sets of information that is composed of separate elements that are analyzed by a model to detect objects included in the separate elements. The revised training data set 120 includes annotated images 108-2 having objects 110-2 that were mis-detected during the inferencing on the set of unannotated images 116. In other words, the revised training data set 120 at least includes the images with mis-detected objects 118. Continuing with the example from above, the revised training data set 120 can include at least 5 annotated images 108-2 that were mis-detected during inferencing by the trained CNN model 104. For example, the 5 annotated images 108-2 may include objects 110-2 that were not identified, such as faces that were not identified. In another implementation, the 5 annotated images 108-2 may include, objects 110-2 that were misidentified, including an animal's face as a human face, a hockey mask as a human face, text misidentified as a human face, a high-texture portion of an image misidentified as a human face, among other examples.

In some examples, in addition to the 5 annotated images 108-2 that had false positive and/or false negative detections, the revised training data set 120 can further include annotated images 108-2 that have similar features to the 5 images with false positive and/or false negative detections. For example, the revised training data set 120 can include an annotated image 108-2 that has a football mask (e.g., similar to a hockey mask), among other examples, which can be utilized to help further train the trained CNN model 104, as is further described herein.

The computing device 102 causes the trained CNN model 104 to be further trained with the revised training data set 120 to detect the object 110-2 included in the annotated images 108-2 included in the revised training data set 120. For example, the trained CNN model 104 is further trained by detecting objects 110-2 included in an input data set (e.g., the revised training data set 120) to revise the trained CNN model 104. Further training the trained CNN model 104 (e.g., so that the trained CNN model 104 is revised) can help the trained CNN model 104 further determine parameters for the model to not mis-detect images 108-2 that were previously mis-detected. Accordingly, the revised CNN model 104 can produce a lower error rate than the trained CNN model 104, as is further described herein.

Once the trained CNN model 104 is revised, the revised CNN model 104 can be utilized to again detect objects in unannotated images. The computing device 102 causes the revised CNN model 104 to perform inferencing on the unannotated images 116 included in the inference data set 114 to detect the object 110-3 in the unannotated images 116. Since the revised CNN model 104 is further trained with the revised training data set 120, it can detect certain objects 110-3 in the unannotated images 116, including images that previously had mis-detected objects.

In some examples, certain objects 110-3 on the unannotated images 116 may again not be detected by the revised CNN model 104. Accordingly, the error rate of the revised CNN model 104 can be determined. For example, the trained CNN model 104 may incorrectly detect (e.g., mis-detect) objects in 1 out of 100 unannotated images, resulting in an error rate of 1%.

The computing device 102 can again compare the error rate to a threshold amount. For example, the computing device 102 can compare the error rate (e.g., 1%) to a predetermined threshold amount (e.g., 0.5%). The computing device 102 may again determine the error rate is greater than the threshold amount. In response to the error rate of the revised CNN model 104 being greater than the threshold amount, the computing device 102 can cause the revised CNN model 104 to be further trained again with another revised training data set including annotated images having objects that were mis-directed during the second inferencing step by the revised CNN model 104.

Such a process may be iterated. For example, the CNN model 104 may be continually trained and retrained with revised training data sets until the error rate of detection of objects from the inference data set 114 during the inferencing step is below the threshold amount.

As such, training models for object detection according to the disclosure can allow for object detection with increased accuracy as compared with previous approaches. By continuously updating the CNN model with revised training data sets with images having previously mis-identified objects, the CNN model may be made to better identify objects included in images.

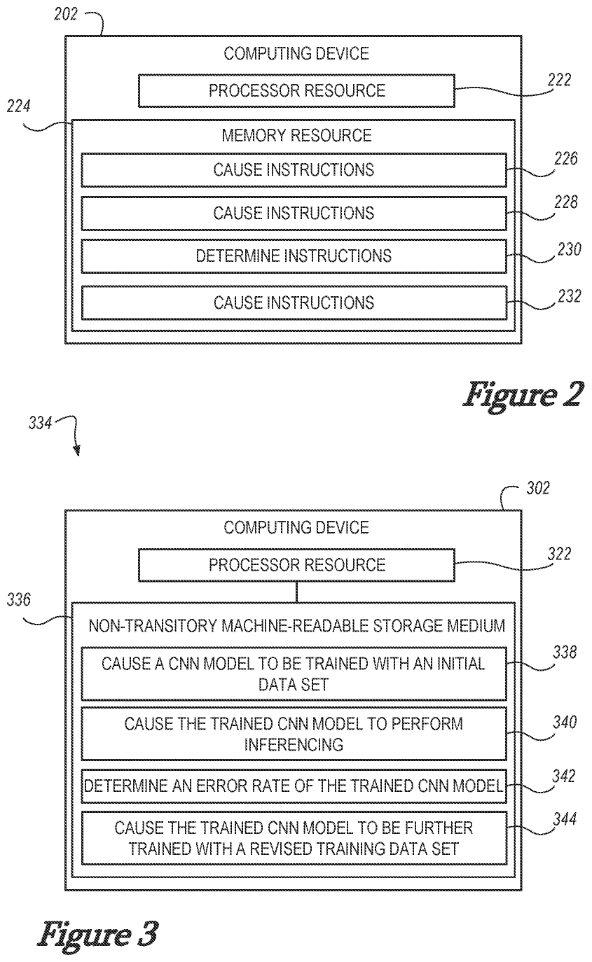

FIG. 2 is an example of a computing device 202 for training models for object detection consistent with the disclosure. As described herein, the computing device 202 may perform functions related to training models for object detection. Although not illustrated in FIG. 2, the computing device 202 may include a processor and a machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple machine-readable storage mediums and across multiple processors. Put another way, the instructions executed by the computing device 202 may be stored across multiple machine-readable storage mediums and executed across multiple processors, such as in a distributed or virtual computing environment.

Processor resource 222 may be a central processing unit (CPU), a semiconductor-based microprocessor, and/or other hardware devices suitable for retrieval and execution of machine-readable instructions 226, 228, 230, 232 stored in a memory resource 224. Processor resource 222 may fetch, decode, and execute instructions 226, 228, 230, 232. In another implementation, processor resource 222 may include a plurality of electronic circuits that include electronic components for performing the functionality of instructions 226, 228, 230, 232.

Memory resource 224 may be any electronic, magnetic, optical, or other physical storage device that stores executable instructions 226, 228, 230, 232, and/or data. Thus, memory resource 224 may be, for example, Random Access Memory (RAM), an Electrically-Erasable Programmable Read-Only Memory (EEPROM), a storage drive, an optical disc, and the like. Memory resource 224 may be disposed within computing device 202, as shown in FIG. 2. Additionally, memory resource 224 may be a portable, external or remote storage medium, for example, that causes computing device 202 to download the instructions 226, 228, 230, 232 from the portable/external/remote storage medium.

The computing device 202 may include instructions 226 stored in the memory resource 224 and executable by the processing resource 222 to cause a CNN model to be trained with an initial training data set to detect an object included in annotated images included in the initial training data set. The object can be, for example, faces of subjects in the annotated images.

The computing device 202 may include instructions 228 stored in the memory resource 224 and executable by the processing resource 222 to cause the trained CNN model to perform inferencing on unannotated images included in an inference data set to detect the object in the unannotated images. The inferencing can be performed on unannotated images to determine whether the trained CNN model produces any misdetections of objects.

The computing device 202 may include instructions 230 stored in the memory resource 224 and executable by the processing resource 222 to determine an error rate of the trained CNN model. The error rate of the CNN model is a rate of misdetection of the object in the unannotated images. Misdetections can include false negative detections and/or false positive detections.

The computing device 202 may include instructions 232 stored in the memory resource 224 and executable by the processing resource 222 to cause the trained CNN model to be further trained based on the error rate. For example, if the error rate exceeds a threshold amount, the computing device 202 can cause the CNN model to be further trained. This process can be iteratively repeated until the error rate is below a threshold amount.

FIG. 3 is a block diagram of an example system 334 for training models for object detection consistent with the disclosure. In the example of FIG. 3, system 334 includes a computing device 302 including a processor resource 322 and a non-transitory machine-readable storage medium 336. Although the following descriptions refer to a single processor resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor resource 322 may be a central processing unit (CPU), microprocessor, and/or other hardware device suitable for retrieval and execution of instructions stored in the non-transitory machine-readable storage medium 336. In the particular example shown in FIG. 3, processor resource 322 may receive, determine, and send instructions 338, 340, 342, 344. In another implementation, processor resource 322 may include an electronic circuit comprising a number of electronic components for performing the operations of the instructions in the non-transitory machine-readable storage medium 336. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 336 may be any electronic, magnetic, optical, or other physical storage device that stores executable instructions. Thus, non-transitory machine-readable storage medium 336 may be, for example, Random Access Memory (RAM), an Electrically-Erasable Programmable Read-Only Memory (EEPROM), a storage drive, an optical disc, and the like. The executable instructions may be “installed” on the system 334 illustrated in FIG. 3. Non-transitory machine-readable storage medium 336 may be a portable, external or remote storage medium, for example, that allows the system 334 to download the instructions from the portable/external/remote storage medium. In this situation, the executable instructions may be part of an “installation package”.

Cause instructions 338, when executed by a processor such as processor resource 322, may cause system 334 to cause a CNN model to be trained with an initial training data set to detect an object included in annotated images included in the initial training data set. The object can be, for example, faces of subjects in the annotated images.

Cause instructions 340, when executed by a processor such as processor resource 322, may cause system 334 to cause the trained CNN model to perform inferencing on unannotated images included in an inference data set to detect the object in the unannotated images. The inferencing can be performed on unannotated images to determine whether the trained CNN model produces any misdetections of objects.

Determine instructions 342, when executed by a processor such as processor resource 322, may cause system 334 to determine an error rate of the trained CNN model, wherein the error rate is a rate of misdetection of the object in the unannotated images. Misdetections can include false negative detections and/or false positive detections.

Cause instructions 344, when executed by a processor such as processor resource 322, may cause system 334 to cause the trained CNN model to be further trained with a revised training data set in response to the error rate being greater than a threshold amount. This process can be iteratively repeated until the error rate is below a threshold amount.

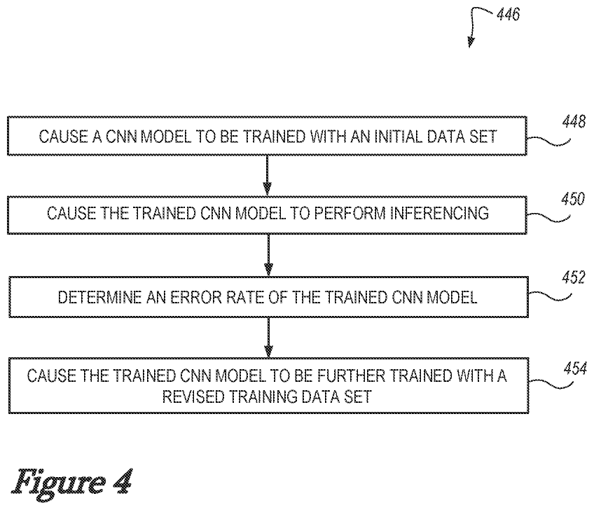

FIG. 4 is an example of a method 446 for training models for object detection consistent with the disclosure. The method 446 can be performed by a computing device (e.g., computing device 102, 202, and 302, previously described in connection with FIGS. 1, 2, and 3, respectively).

At 448, the method 446 includes causing, by a computing device, a CNN model to be trained with an initial training data set to detect an object included in annotated images included in the initial training data set. The object can be, for example, faces of subjects in the annotated images.

At 450, the method 446 includes causing, by the computing device, the trained CNN model to perform inferencing on unannotated images included in an inference data set to detect the object in the unannotated images. The inferencing can be performed on unannotated images to determine whether the trained CNN model produces any misdetections of objects.

At 452, the method 446 includes determining, by the computing device, an error rate of the trained CNN model, wherein the error rate is a rate of misdetection of the object in the unannotated images. Misdetections can include false negative detections and/or false positive detections.

At 454, the method 446 includes causing, by the computing device, the trained CNN model to be further trained with a revised training data set including annotated images having objects that were mis-detected during the inferencing on the set of unannotated images in response to the error rate being greater than a threshold amount. The method 446 can be iteratively repeated until the error rate is below a threshold amount.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 100 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
cause a convolutional neural network (CNN) model to be trained with an initial training data set to detect an object included in annotated images included in the initial training data set;
cause the trained CNN model to perform inferencing on unannotated images included in an inference data set to detect the object in the unannotated images;
determine an error rate of the trained CNN model, wherein the error rate is a rate of misdetection of the object in the unannotated images; and
cause the trained CNN model to be further trained based on the error rate.

2. The computing device of claim 1, wherein the processor resource is to cause the trained CNN model to be further trained with a revised training data set to revise the CNN model.

3. The computing device of claim 2, wherein the revised training data set includes annotated images having objects that were mis-detected during the inferencing on the set of unannotated images.

4. The computing device of claim 1, wherein the processor resource is to cause the trained CNN model to be further trained in response to the error rate being greater than a threshold amount.

5. The computing device of claim 1, wherein the annotated images in the initial training data set are annotated with bounding boxes around the object.

6. The computing device of claim 1, wherein the unannotated images in the inference data set include the object without bounding boxes around the object.

7. The computing device of claim 1, wherein the object is a face of a subject.

8. A non-transitory machine-readable storage medium storing machine-readable instructions stored thereon that, when executed, cause a processor resource to:
cause a convolutional neural network (CNN) model to be trained with an initial training data set to detect an object included in annotated images included in the initial training data set;
cause the trained CNN model to perform inferencing on unannotated images included in an inference data set to detect the object in the unannotated images;
determine an error rate of the trained CNN model, wherein the error rate is a rate of misdetection of the object in the unannotated images; and
cause the trained CNN model to be further trained with a revised training data set in response to the error rate being greater than a threshold amount.

9. The non-transitory memory resource of claim 8, wherein the object is included in a category of objects intended for detection.

10. The non-transitory memory resource of claim 8, wherein misdetection of the object includes an image included in the inference data set having an object to be detected that was not detected.

11. The non-transitory memory resource of claim 8, wherein misdetection of the object includes an image included in the inference data set having an object that was detected, but not being of a category of objects intended for detection.

12. A method, comprising:
causing, by a computing device, a convolutional neural network (CNN) model to be trained with an initial training data set to detect an object included in annotated images included in the initial training data set;
causing, by the computing device, the trained CNN model to perform inferencing on unannotated images included in an inference data set to detect the object in the unannotated images;
determining, by the computing device, an error rate of the trained CNN model, wherein the error rate is a rate of misdetection of the object in the unannotated images; and
causing, by the computing device, the trained CNN model to be further trained with a revised training data set including annotated images having objects that were mis-detected during the inferencing on the set of unannotated images in response to the error rate being greater than a threshold amount.

13. The method of claim 12, wherein the method includes causing, by the computing device, the revised CNN model to perform inferencing on unannotated images included in the inference data set to detect the object in the unannotated images.

14. The method of claim 13, wherein the method includes:
determining, by the computing device, an error rate of the revised CNN model; and
causing, by the computing device, the revised CNN model to be further trained with another revised training data set including annotated images having objects that were mis-detected during the inferencing by the revised CNN model on the set of unannotated images in response to the error rate of the revised CNN model being greater than the threshold amount.

15. The method of claim 12, wherein the method includes iterating the method until the error rate is below the threshold amount.
